(19) United States
(12) Patent Application Publication
(10) Pub. No.: US 2005/0125223 A1
(43) Pub. Date: Jun. 9, 2005

(54) Audio-visual highlights detection using coupled hidden markov models

(76) Inventors: Ajay Divakaran, Burlington, MA (US); Ziyou Xiong, Urbana, IL (US); Regunathan Radhakrishnan, Quincy, MA (US)

Correspondence Address: Patent Department;Mitsubishi Electric Research Laboratories, Inc., 201 Broadway, Cambridge, MA, 02139, US

(21) Appl. No.: 10/729,164

(22) Filed: Dec. 5, 2003

(51) Int. Cl. G10L 19/12; G10L 15/26; G10L 17/00; G10L 15/04; G06K 9/00; G06K 9/20

(52) U.S. Cl. 704/223; 704/249; 704/250; 704/253; 704/235; 382/181; 382/312

(57) ABSTRACT

A method uses probabilistic fusion to detect highlights in videos using both audio and visual information. Specifically, the method uses coupled hidden Markov models (CHMMs). Audio labels are generated using audio classification via Gaussian mixture models (GMMs), and visual labels are generated by quantizing average motion vector magnitudes. Highlights are modeled using discrete-observation CHMMs trained with labeled videos. The CHMMs have better performance than conventional hidden Markov models (HMMs) trained only on audio signals, or only on video frames.

### FIELD OF THE INVENTION

This invention relates generally to processing videos, and more particularly to detecting highlights in videos.

### BACKGROUND OF THE INVENTION

Most prior art systems for detecting highlights in videos use a single signaling modality, e.g., either an audio signal or just a visual signal. Rui et al. detect highlights in baseball games based on an announcer's excited speech and ball-bat impact sound. They use directional template matching only on the audio signal, see Rui et al., “Automatically extracting highlights for TV baseball programs,” Eighth ACM International Conference on Multimedia, pp. 105-115, 2000.

Kawashima et al. extract bat-swing features in video frames, see Kawashima et al., “Indexing of baseball telecast for content-based video retrieval,” 1998 International Conference on Image Processing, pp. 871-874, 1998.

Xie et al. and Xu et al. segment soccer videos into play and break segments using dominant color and motion information extracted only from video frames, see Xie et al., “Structure analysis of soccer video with hidden Markov models,” Proc. International Conference on Acoustic, Speech and Signal Processing, ICASSP-2002, May 2002, and Xu et al., “Algorithms and system for segmentation and structure analysis in soccer video,” Proceedings of IEEE Conference on Multimedia and Expo, pp. 928-931, 2001.

Gong et al. provide a parsing system for soccer games. The parsing is based on visual features such as the line pattern on the playing field, and the movement of the ball and players, see Gong et al., “Automatic parsing of TV soccer programs,” IEEE International Conference on Multimedia Computing and Systems, pp. 167-174, 1995.

Ekin et al. analyze a soccer video based on shot detection and classification. Again, interesting shot selection is based only on visual information, see Ekin et al., “Automatic soccer video analysis and summarization,” Symp. Electronic Imaging: Science and Technology: Storage and Retrieval for Image and Video Databases IV, January 2003.

Therefore, it is desired to detect highlights from videos based on both audio and visual information.

### SUMMARY OF THE INVENTION

The invention uses probabilistic fusion to detect highlights in videos using both audio and visual information. Specifically, the invention uses coupled hidden Markov models (CHMMs), and in particular, the processed videos are sports videos. However, it should be noted, that the invention can also be used to detect highlights in other types of videos, such as action or adventure movies, where the audio and visual content are correlated.

First, audio labels are generated using audio classification via Gaussian mixture models (GMMs), and visual labels are generated by quantizing average motion vector magnitudes. Highlights are modeled using discrete-observation CHMMs trained with labeled videos. The CHMMs have better performance than conventional hidden Markov models (HMMs) trained only on audio signals, or only on video frames.

The coupling between two single-modality HMMs improves the modeling by making refinements on states of the models. CHMMs provide a useful tool for information fusion techniques and audio-visual highlight detection.

### BRIEF DESCRIPTION OF THE DRAWINGS

FIG. 1 is a block diagram of a system and method for detecting highlights in videos according to the invention;

FIG. 2 is a block diagram of extracting and classifying audio features;

FIG. 3 is a block diagram of extracting and classifying visual features;

FIG. 4 is a block diagram of a discrete-observation coupled hidden Markov model according to the invention; and

FIG. 5 is a block diagram of a user interface according to the invention.

### DETAILED DESCRIPTION OF THE PREFERRED EMBODIMENT

Because the performance of highlight detection based only on audio features in a video degrades drastically when the background noise increases, we also use complementary visual features that are not corrupted by the acoustic noise generated by an audience or a microphone.

System and Method Overview

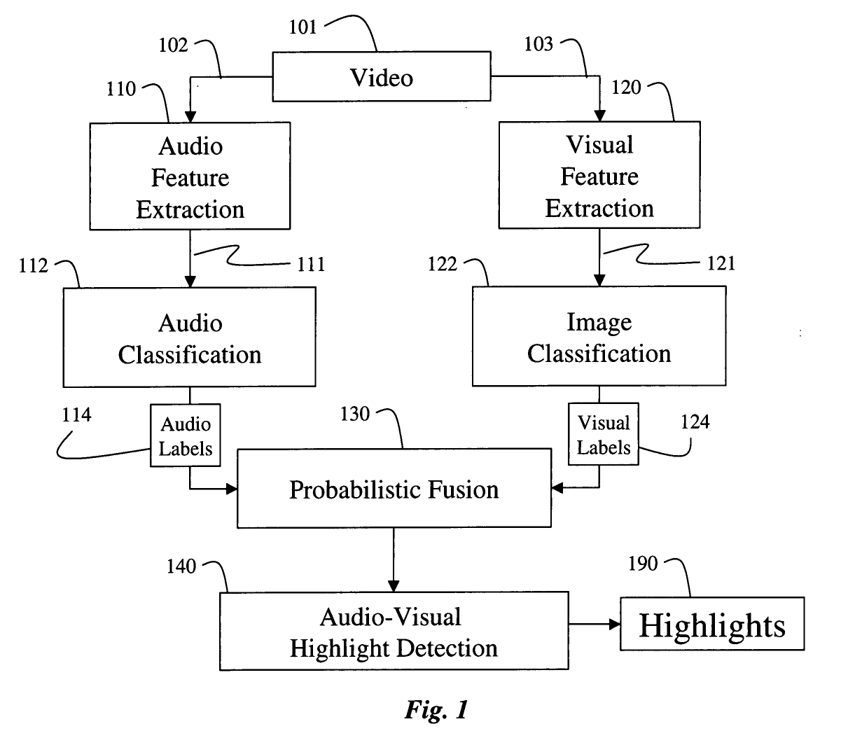

As shown in FIG. 1, our invention takes a video 101 as input. The video can be partitioned into shots using conventional shot or scene detection techniques. The video is first demultiplexed into an audio portion 102 and a visual portion 103. Audio features 111 are extracted 110 from the audio portion 102 of the video 101, and visual features 121 are extracted 120 from frames 103 constituting the visual portion of the video. It should be noted that the features can be extracted from a compressed video, e.g., a MPEG compressed video.

Audio labels 114 are generated 112 for classified audio features. Visual labels 124 are also generated 122 according to classified visual features.

Then, probabilistic fusion 130 is applied to the labels to detect 140 highlights 190.

Audio Feature Extraction and Classification

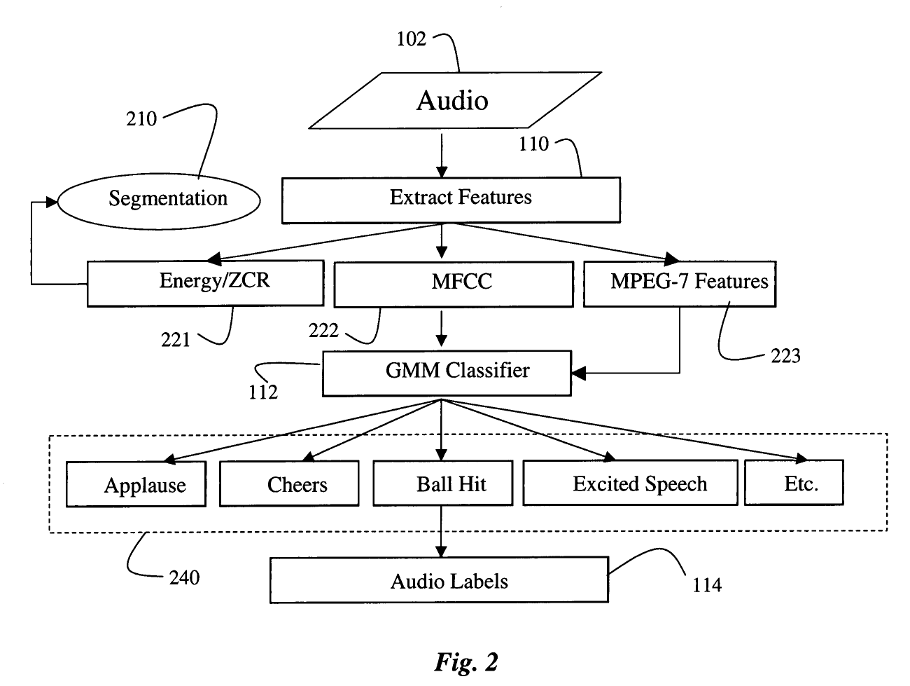

FIG. 2 shows the audio classification in greater detail. We are motivated to use audio classification because the audio labels are related directly to content semantics. We segment 210 the audio signal 102 into audio frames, and extract 110 audio features from the frames.

We use, for example, the 4 Hz modulation energy and zero cross rate (ZCR) 221 to label silent segments. We extract Me1-scale frequency cepstrum coefficients (MFCC) 222 from the segmented audio frames. Then, we use Gaussian mixture models (GMM) 112 to label seven classes 240 of sounds individually. Other possible classifiers include nearest neighbor and neural network classifiers. These seven labels are: applause, ball-hit, female speech, male speech, music, music with speech and noise such as audience noise, cheering, etc. We can also use MPEG-7 audio descriptors as the audio labels 114. These MPEG-7 descriptors are more detailed and comprehensive, and apply to all types of videos.

Visual Feature Extraction and Classification

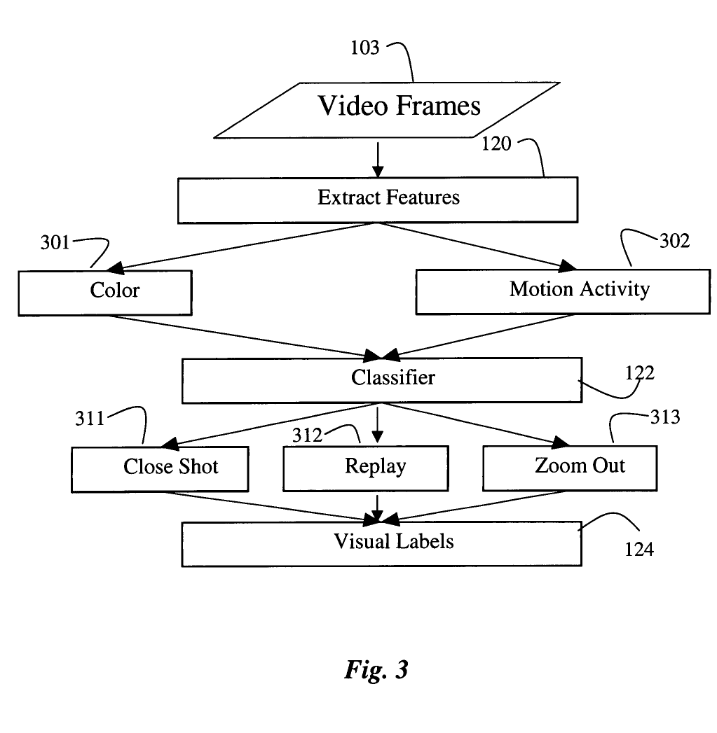

FIG. 3 shows the details of the visual analysis. We use a modified version of the MPEG-7 motion activity descriptor to generate video labels 124. The MPEG-7 motion activity descriptor captures the intuitive notion of ‘intensity of action’ or ‘pace of action’ in a video segment, see Cabasson et al., “Rapid generation of sports highlights using the MPEG-7 motion activity descriptor,” SPIE Conference on Storage and Retrieval from Media Databases, 2002. Possible features include dominant color 301 and motion activity 302.

The motion activity is extracted by quantizing the variance of the magnitude of the motion vectors from the video frames between two neighboring P-frames to one of five possible labels: very low, low, medium, high, very high. The average motion vector magnitude also works well with lower computational complexity.

We quantize the average of the magnitudes of motion vectors from those video frames between two neighboring P-frames to one of four labels: very low, low, medium, high. Other possible labels 124 include close shot 311, replay 312, and zoom 313.

Discrete-Observation Coupled Hidden Markov Model (DCHMM)

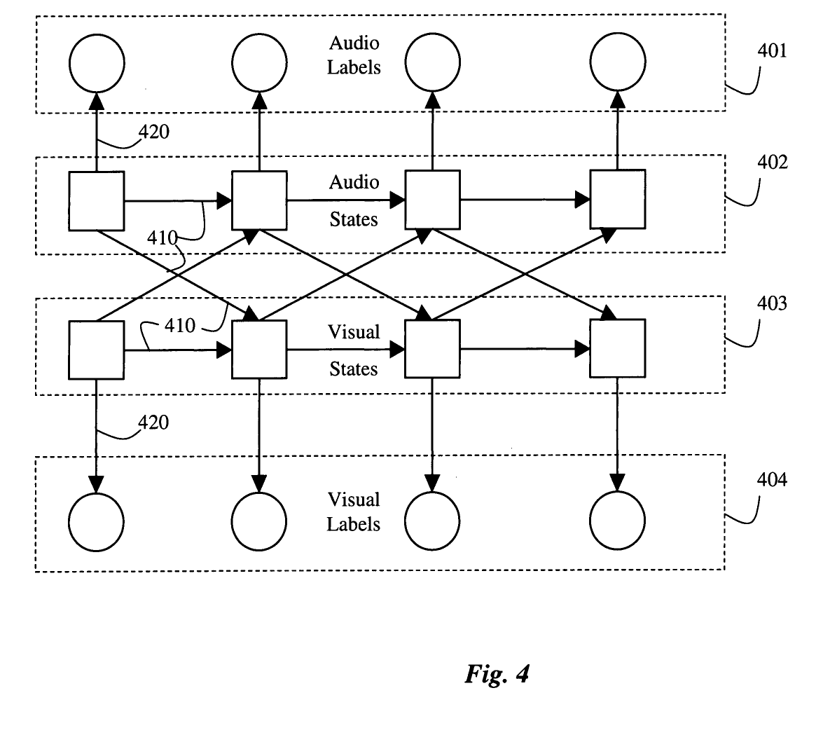

FIG. 4 shows one embodiment of a probabilistic fusion that the invention can use.

Probabilistic fusion can be defined as follows. Without loss of generality, consider two signaling modalities A and B that use features f_{A} and f_{B}. Then, a fusion function F(f_{A}, f_{B}) estimates the probability of the target event. E related to the features f_{A} and f_{B}, or of their corresponding signaling modes. We can generalize this definition to any number of features.

Therefore, each distinct choice of the function F(f_{A}, f_{B}) gives rise to a distinct technique for probabilistic fusion. A straightforward choice would be carry out supervised clustering to find a cluster C that corresponds to the target event E. Then an appropriate scaling and thresholding of the distance of the test feature vector from the centroid of the cluster C gives the probability of the target event E, and thus would serve as the function F as defined above.

Neural nets offer another possibility in which a training process leads to linear hyperplanes that divide the feature space into regions that correspond to the target event, or not. In this case, the scaled and thresholded distance of the feature vector from the boundaries of the regions serves as the function F.

Hidden Markov Models (HMM) have the advantage of incorporating the temporal dynamics of the feature vectors into the function F. Thus, any event that is distinguished by its temporal dynamics is classified better using HMM's. For instance, in golf, high motion caused by a good shot is often followed by applause. Such a temporal pattern is best captured by HMM's. Thus, in this work, we are motivated to use coupled HMM's to determine the probability of the target event E. In this case, the likelihood output from the HMM serves as the function F as defined above.

In FIG. 4, the probabilistic fusion is accomplished with a discrete-observation coupled hidden Markov model (DCHMM). Circular nodes 401 represent the audio labels, square nodes 402 are the states of the audio HMMs, square nodes 403 are the states of the visual HMMS, and circular nodes 404 are the visual labels.

The horizontal and diagonal arrows 410 ending at the squares node represent a transition matrix of the CHMM:

$$\begin{matrix}{a}_{( i , j ) , k}^{1} = Pr ( {S}_{t + 1}^{1} = k \vert {S}_{t}^{1} = i , {S}_{t}^{2} = j ) \\ 1 \leq i , k \leq M ; 1 \leq j \leq N\end{matrix} \qquad ( 1 )$$

where S¹ represents the audio states and S² the visual states. That is, the probability (Pr) of transiting to state k in the first Markov chain at the next time instant given the current two hidden states are i and j, respectively. The total number of states for two Markov chains are M and N, respectively. Similarly, we define

$$\begin{matrix}{a}_{( i , j ) , l}^{2} = Pr ( {S}_{t + 1}^{2} = l \vert {S}_{t}^{1} = i , {S}_{t}^{2} = j ) \\ 1 \leq i \leq M ; 1 \leq j , l \leq N .\end{matrix} \qquad ( 2 )$$

The parameters associated with the vertical arrows 420 determine the probability of an observation given the current state. For modeling the discrete-observation system with two state variables, we generate a single HMM from the Cartesian product of their states, and similarly, the Cartesian product of their observations, see Brand et al., “Coupled hidden Markov models for complex action recognition,” Proceedings of IEEE CVPR97, 1996, and Nefian et al., “A coupled HMM for audio-visual speech recognition,” Proceedings of International Conference on Acoustics Speech and Signal Processing, vol. II, pp. 2013-2016, 2002.

We transform the coupling of two HMMs with M and N states respectively into a single HMM with M×N states with the following state transition matrix definition:

$$\begin{matrix}{a}_{( i , j ) , ( k , l )} = Pr ( {S}_{t + 1}^{1} = k , {S}_{t + 1}^{2} = l \vert {S}_{t}^{1} = i , {S}_{t}^{2} = j ) \\ 1 \leq i , k \leq M ; 1 \leq j , l \leq N .\end{matrix} \qquad ( 3 )$$

This involves a “packing” and an “un-packing” of parameters from the two coupled HMMs to the single product HMM. A conventional forward-backward process can be used to learn the parameters of the product HMM, based on a maximum likelihood estimation. A Viterbi algorithm can be used to determine the optimal state sequence given the observations and the model parameters. For more detail on the forward-backward algorithm and the Viterbi algorithm, see Rabiner, “A tutorial on hidden Markov models and selected applications in speech recognition,” Proceedings of the IEEE, vol. 77, no. 2, pp. 257-86, February 1989.

Probabilistic Fusion with CHMM

We train the audio-visual highlight CHMM 402-403 using hand labeled videos. The training videos includes highlights such as golf club swings followed by audience applause, goal scoring opportunities and cheering, etc. Our motivation of using discrete-time labels is that it is more computationally efficient to learn the discrete-observation CHMM than it is to learn a continuous-observation CHMM.

With discrete-time labels, it is unnecessary to model the observations using the more complex Gaussian functions, or mixture of Gaussian functions. We align the two sequences of labels by up-sampling the video labels to match the length of the audio label sequence for the highlight examples in the training videos.

Then, we select the number of states of the CHMMs by analyzing the semantic meaning of the labels corresponding to each state decoded by the Viterbi algorithm.

Due to the inherently diverse nature of the non-highlight events in sports videos, it is difficult to collect good negative training examples. Therefore, we do not attempt to learn a non-highlight CHMM.

We threshold adaptively the likelihoods of the video segments, taken sequentially from the sports videos, using only the highlight CHMM. The intuition is that the highlight CHMM will produce higher likelihoods for highlight segments and lower likelihoods for non-highlight segments.

User Interface

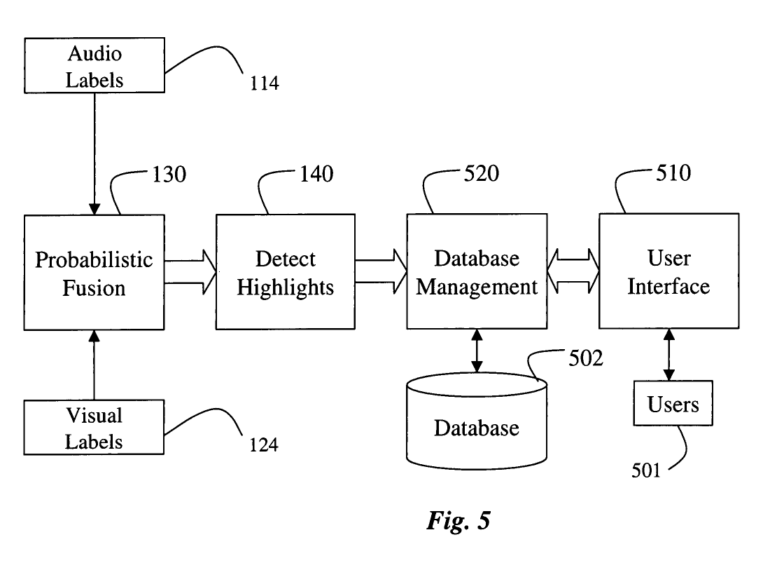

As shown in FIG. 5, one important application of highlight detection in videos is to provide users 501 correct entry points to stored video content 502 so the users can adaptively select other interesting contents with an interface 510 that are not necessarily modeled by training videos. The user interface 510 interacts with a database management subsystem 520. This requires a progressive highlight generation process. Depending on how long the sequence of highlights the users want to view, the system can provide the most likely sequences that contain highlights.

Therefore, we use a content-adaptive threshold. A lowest threshold is a smallest likelihood, and a highest threshold is a largest threshold over all video sequences. Then, given a time budget, we can determine the value of the thresholds. A total length of highlight segments is as close to the budget as possible. Then, we can play those segments with likelihood greater than the threshold one after another until the budget is exhausted.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A method for detecting highlights from videos, comprising:
extracting audio features from the video;
classifying the audio features as labels;
extracting visual features from the video;
classifying the visual features as labels; and
fusing, probabilistically, the audio labels and visual labels to detect highlights in the video.

2. The method of claim 1, in which the video is compressed.

3. The method of claim 1, in which silent features are classified according to audio energy and zero cross rate.

4. The method of claim 1, in which the audio features are Me1-scale frequency cepstrum coefficients.

5. The method of claim 1, in which the audio features are MPEG-7 descriptors.

6. The method of claim 1, in which the audio features are classified using Gaussian mixture models.

7. The method of claim 1, in which the audio labels are selected from the group consisting of applause, cheering, ball hit, music, male speech, female speech, and speech with music.

8. The method of claim 1, in which the visual features are based on motion activity descriptors.

9. The method of claim 1, in which the visual features include dominant color and motion vectors.

10. The method of claim 1, in which a variance of the motion activity is quantized to obtain the visual labels.

11. The method of claim 1, in which the motion activity is averaged to obtain the visual labels.

12. The method of claim 1, in which the visual labels are selected from the group consisting of close shot, replay, and zoom.

13. The method of claim 1, in which the probabilistic fusion uses a discrete-observation coupled hidden Markov model.

14. The method of claim 13, in which the discrete-observation coupled hidden Markov model includes audio hidden Markov models and visual hidden Markov models.

15. The method of claim 14, in which the discrete-observation coupled hidden Markov model is generated from a Cartesian product of states of the audio hidden Markov models and the visual hidden Markov models, and a Cartesian product of observations of the audio hidden Markov models and the visual hidden Markov models.

16. The method of claim 13, further comprising:
training the discrete-observation coupled hidden Markov model with hand labeled videos.

17. The method of claim 1, in which the video is a sport video.

18. The method of claim 1, further comprising:
determining likelihoods for the highlights; and
thresholding the highlights.

19. The method of claim 1, in which the audio portion of the video is compressed.

20. The method of claim 1, in which the visual portion of the video is compressed.
